(19) United States
(12) Patent Application Publication
(10) Pub. No.: US 2017/0274825 A1
(43) Pub. Date: Sep. 28, 2017

(54) VEHICLE COMMUNICATION SYSTEM

(71) Applicant: Ford Global Technologies, LLC, Dearborn, MI (US)

(72) Inventors: David R. Woodhouse, Troy, MI (US); Soo Young Kang-Morales, Northville, MI (US); Ryan G. Niemiec, Northville, MI (US); Craig Michael Sandvig, Sterling Heights, MI (US); Chacko Abraham, Birmingham, MI (US)

(73) Assignee: Ford Global Technologies, LLC

(21) Appl. No.: 15/446,096

(22) Filed: Mar. 1, 2017

Related U.S. Application Data
(60) Provisional application No. 62/312,265, filed on Mar. 23, 2016.

(51) Int. Cl. B60R 1/00; B60N 2/48; B60N 2/64; H04N 5/247; B60R 11/02

(52) U.S. Cl. CPC B60R 1/008; H04N 5/247; B60R 11/0229; B60N 2/64; B60N 2/48; H04N 21/41422

(57) ABSTRACT

A vehicle includes a vehicle seating assembly defining a first occupant space. The assembly includes a seat bottom and a seat back operably coupled to the seat bottom. The seat back includes a head rest area and a back panel. A display is positioned on a rear of the seat back. A first camera is positioned within the display and configured to transmit a first video signal. A human machine interface includes a screen configured to display the first video signal from the first camera.

### CROSS-REFERENCE TO RELATED APPLICATION

This application claims benefit from U.S. Provisional Patent Application No. 62/312,265, which was filed on Mar. 23, 2016, entitled VEHICLE COMMUNICATION SYSTEM, the entire disclosure of which is hereby incorporated herein by reference.

### FIELD OF THE INVENTION

The present disclosure generally relates to vehicle communication systems and, more particularly, relates to vehicle video communication systems

### BACKGROUND OF THE INVENTION

Communication within a vehicle may be inconvenient due to positioning of seats of the vehicle. It is therefore desired to implement communication systems in automotive vehicles for improving communication and information transfer.

### SUMMARY OF THE INVENTION

According to one feature of the present disclosure, a vehicle includes a vehicle seating assembly defining a first occupant space. The assembly includes a seat bottom and a seat back operably coupled to the seat bottom. The seat back includes a head rest area and a back panel. A display is positioned on a rear of the seat back. A first camera is positioned within the display and configured to transmit a first video signal. A human machine interface includes a screen configured to display the first video signal from the first camera.

According to another feature of the present disclosure, a vehicle includes a first vehicle seating assembly defining a first occupant space. A second vehicle seating assembly defines a second occupant space. A display is positioned on a rear of the first seating assembly. A camera is positioned within the display and configured to image the second occupant space.

According to another feature of the present disclosure, a vehicle cabin includes a first camera and a second camera positioned within the cabin. The first and second cameras are configured to image respective first and second spaces within the cabin. A first display is configured to display a first video signal from the first camera. A second display is configured to display a second video signal from the second camera.

### BRIEF DESCRIPTION OF THE DRAWINGS

In the drawings:

FIG. 1A illustrates a top side view of an interior of a vehicle having a communication system, according to one embodiment;

FIG. 1B illustrates a top rear view of the interior of the vehicle having the communication system, according to one embodiment;

FIG. 1C illustrates a top elevational view of the interior of the vehicle having the communication system, according to one embodiment;

FIG. 1D illustrates a side elevational view of the interior of the vehicle having the communication system, according to one embodiment;

FIG. 1E illustrates a front perspective view of the interior of the vehicle having the communication system, according to one embodiment;

FIG. 1F illustrates a front elevational view of the interior of the vehicle having the communication system, according to one embodiment;

FIG. 1G illustrates a front elevational view of the interior of the vehicle having the communication system, according to one embodiment;

FIG. 2A illustrates a rear perspective view of a vehicle seating assembly having the communication system, according to one embodiment;

FIG. 2B illustrates a top rear view of the vehicle seating assembly having the communication system, according to one embodiment;

FIG. 3 illustrates a top elevational view of the vehicle seating assembly having the communication system, according to one embodiment;

FIG. 4 illustrates a block diagram of a control system for the communication system, according to one embodiment; and

FIG. 5 illustrates a method of operating the vehicle communication system, according to one embodiment.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items. For example, if a composition is described as containing components A, B, and/or C, the composition can contain A alone; B alone; C alone; A and B in combination; A and C in combination; B and C in combination; or A, B, and C in combination.

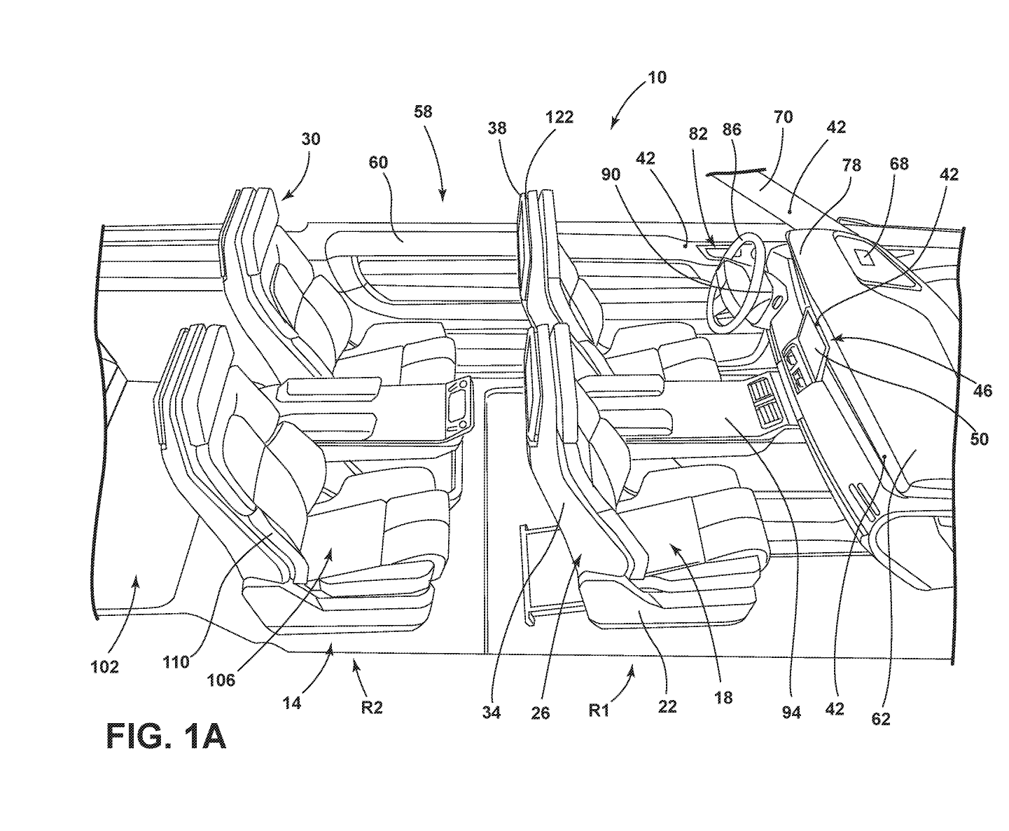

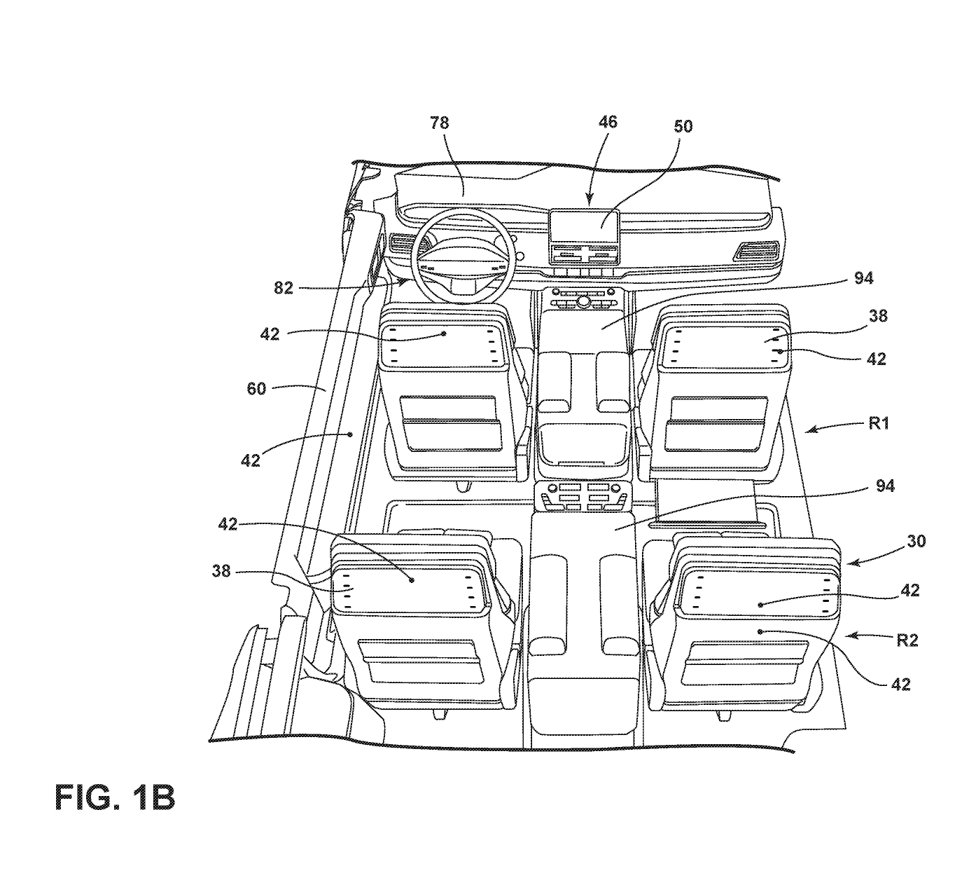

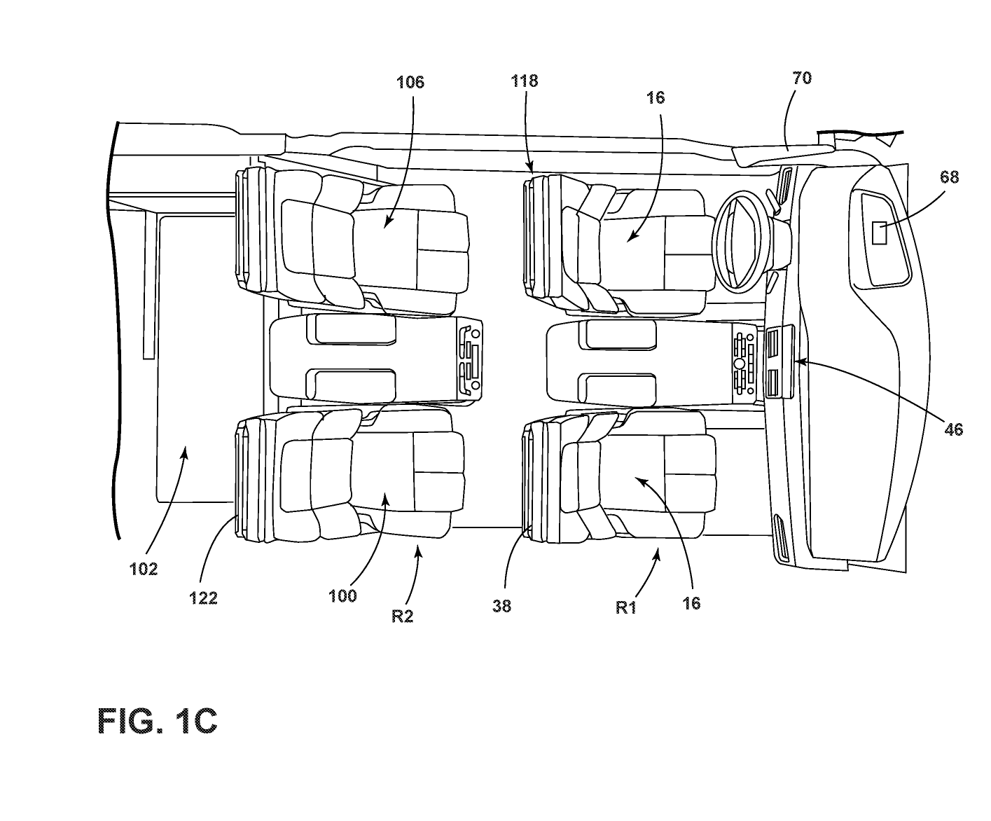

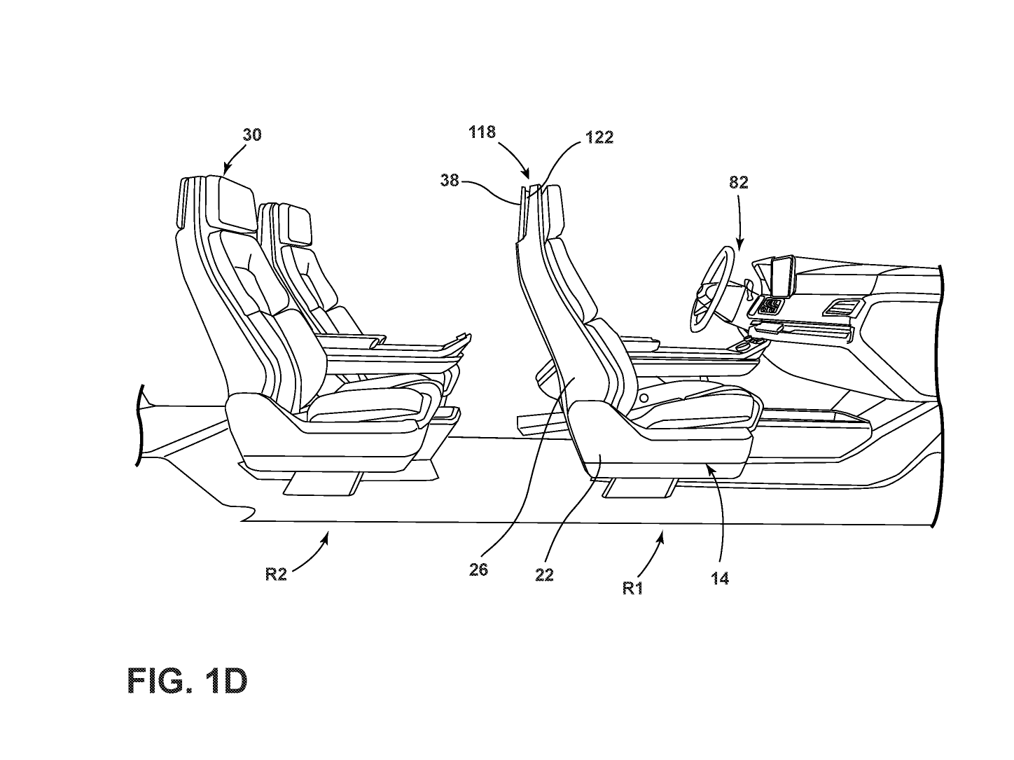

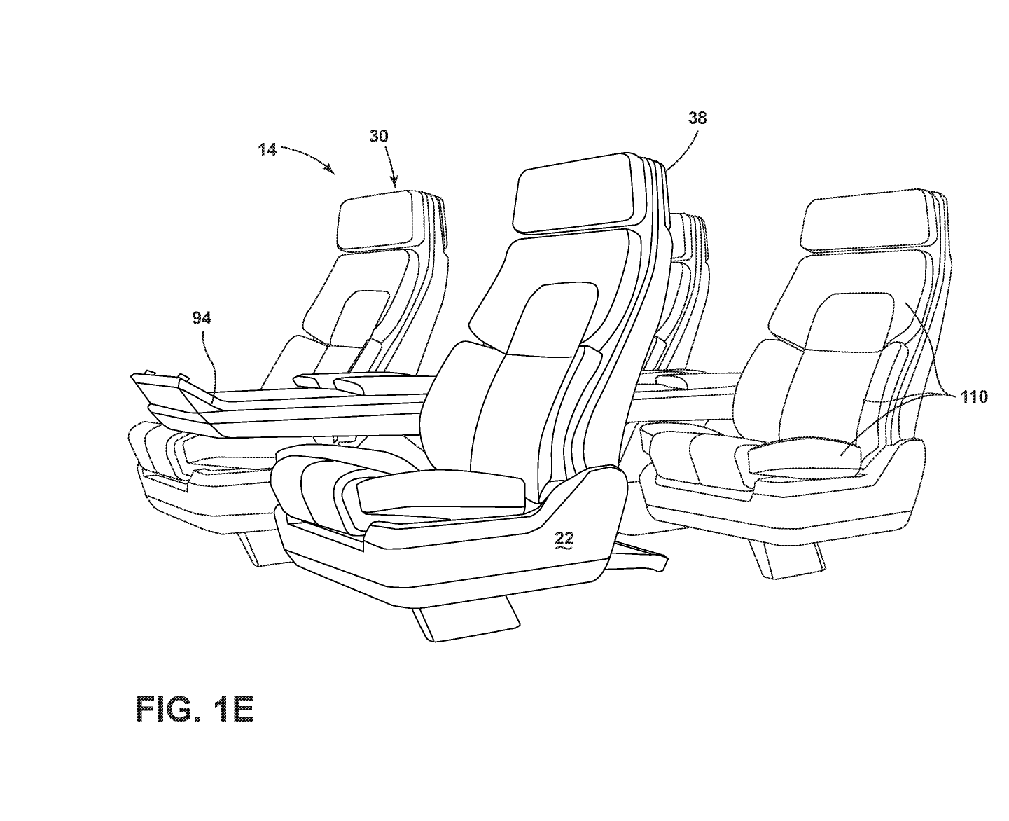

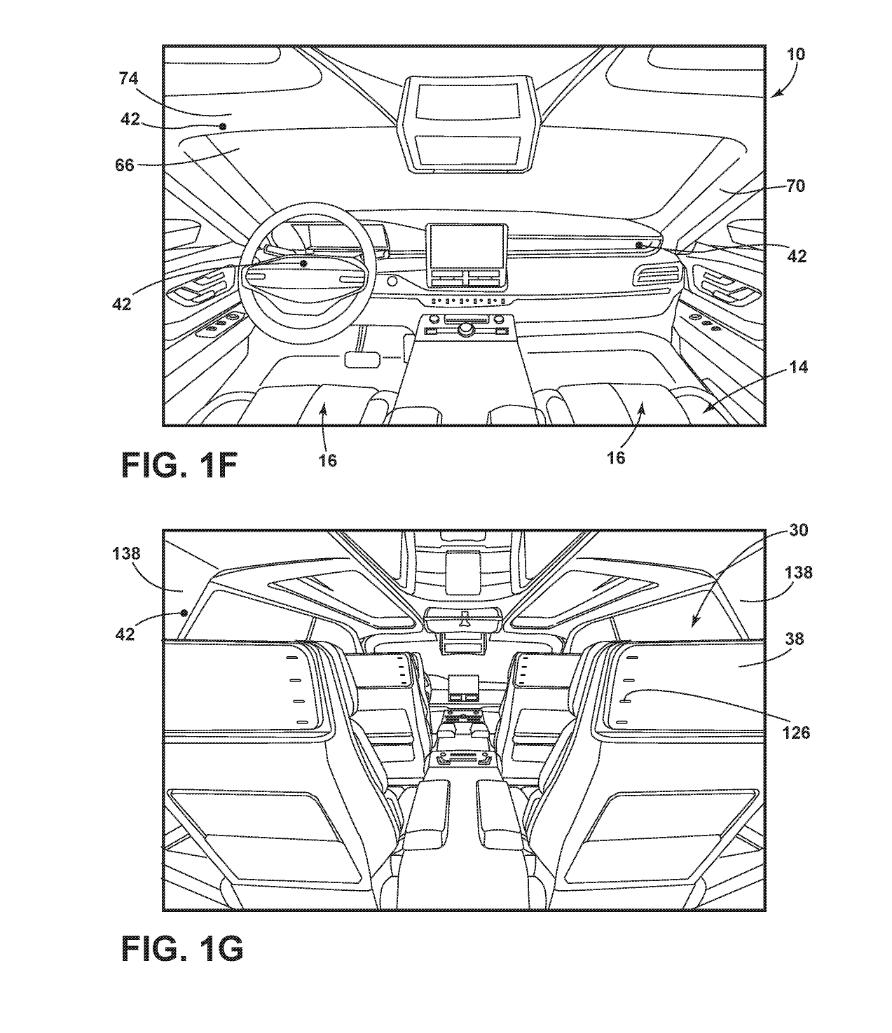

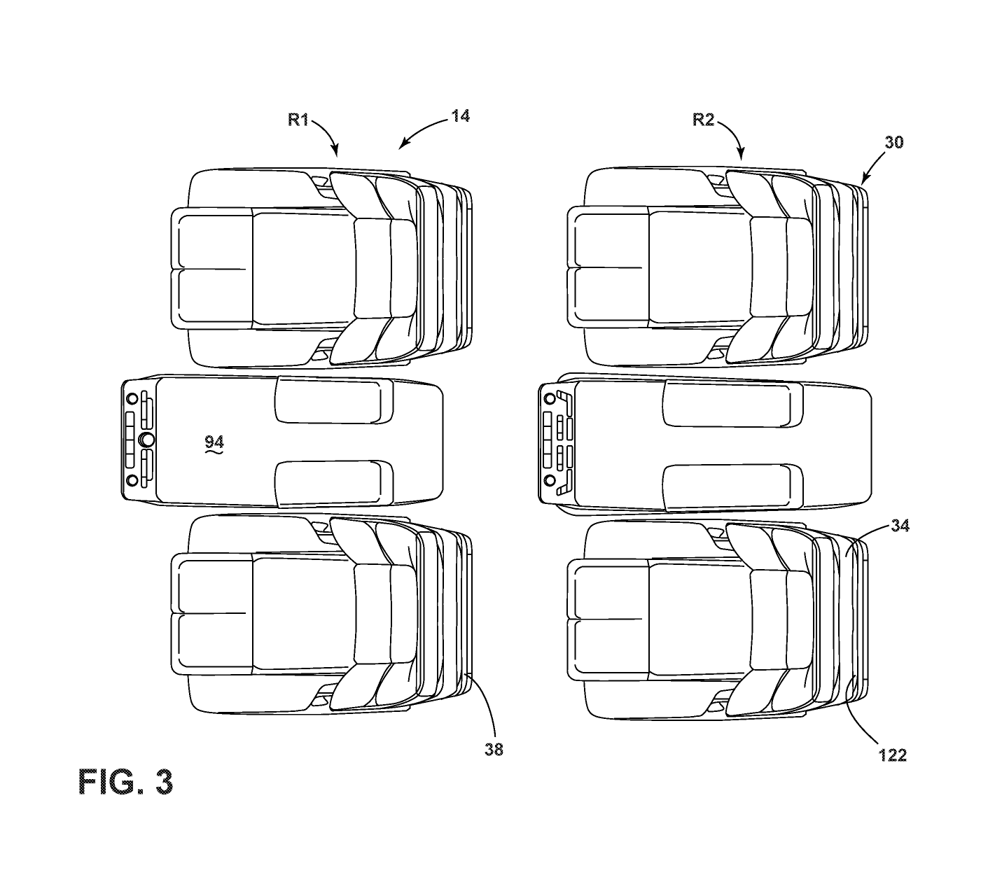

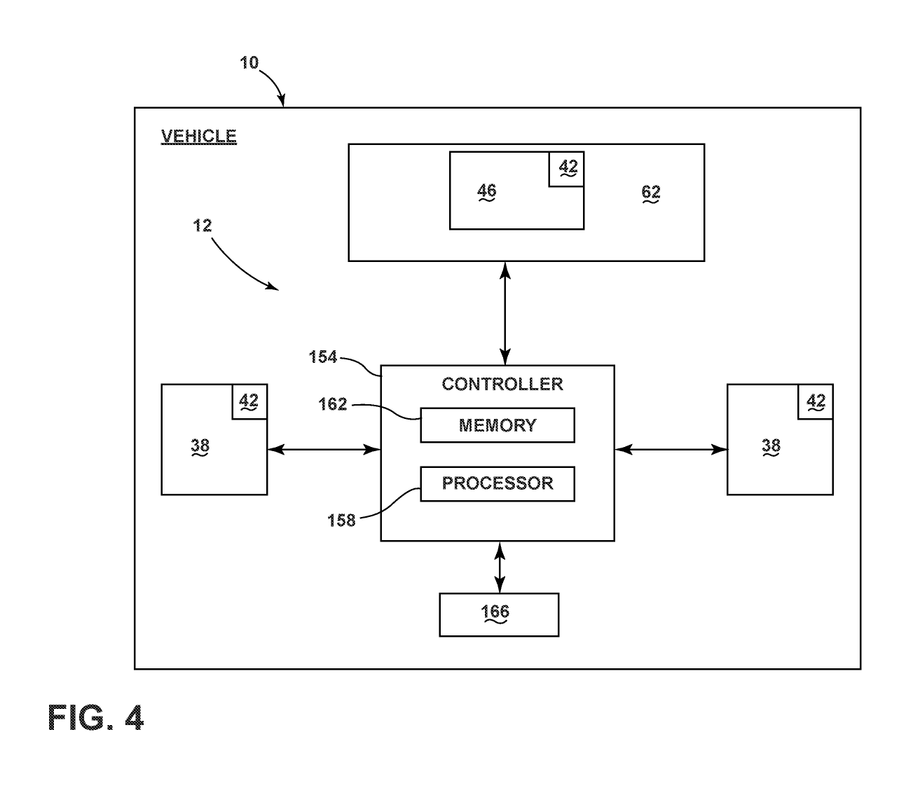

Referring now to FIGS. 1A-5, reference numeral 10 generally designates a vehicle in which a vehicle communication system 12 (FIG. 4) is disposed. The vehicle 10 includes a vehicle seating assembly 14 defining a first occupant space 18. The vehicle seating assembly 14 includes a seat bottom 22 and a seat back 26 operably coupled to the seat bottom 22. The seat back 26 includes a head rest area 30 and a back panel 34. A display 38 is positioned on the back panel 34 of the seat back 26. A camera 42 is disposed within the display 38 and configured to transmit a video signal. A human machine interface (HMI) 46 includes a screen 50 configured to display the video signal from the camera 42.

Referring now to FIGS. 1A-1G, the vehicle 10 defines a cabin 58 around which a plurality of doors 60 are positioned. The vehicle seating assemblies 14 are positioned within the cabin 58. An instrument panel 62 is disposed within the cabin 58 of the vehicle 10. The instrument panel 62 is positioned at a vehicle front location of the cabin 58. The instrument panel 62 may include one or more veneers or inlays configured to provide a decorative appearance to the instrument panel 62. The instrument panel 62 is positioned below a windshield 66. A heads-up display 68 may be positioned within the instrument panel 62, proximate a driver side of the vehicle 10, and configured to project one or more images onto an interior of the windshield 66 as explained in greater detail below. On both outboard ends of the windshield 66 are A-pillars 70. The A-pillars 70 generally extend from proximate the instrument panel 62 towards a headliner 74. The A-pillars 70 are configured to support a roof of the vehicle 10 and the windshield 66. The HMI 46 may be integrated into the instrument panel 62. In the depicted example, the HMI 46 is disposed in a center of the instrument panel 62, but may also be positioned on the driver side, or a passenger side, of the vehicle 10 without departing from the spirit of the disclosure and the teachings provided herein. Further, the HMI 46 may be positioned above or below the instrument panel 62. The HMI 46 includes the screen 50 configured to display one or more images. The HMI 46 may show navigation information (e.g., location and/or route information), vehicle information (e.g., speed, revolutions per minute of the engine, fuel level) and/or a video signal from one or more of the cameras 42, as explained in greater detail below. Further, the HMI 46 may permit browsing of the internet and/or browsing and playing of stored media. The HMI 46 may include a plurality of physical keys, virtual keys, knobs, or other instruments configured to allow an occupant of the vehicle 10 to operate the HMI 46. The HMI 46 may additionally include one or more speakers, audio jacks, or connections and/or microphones for audio information to be input or output from the HMI 46. The instrument panel 62 may define, or otherwise be coupled to, an instrument cluster hood 78. Extending below the instrument cluster hood 78 is a steering wheel assembly 82 having a steering wheel 86 and a steering column 90.

The vehicle seating assembly 14 is positioned vehicle rearward of the instrument panel 62. In various embodiments, the vehicle 10 may include a plurality of vehicle seating assemblies 14 positioned in rows (e.g., a first row R1 including a driver's seating assembly 14 and front passenger seating assembly 14, a second row R2 and optionally a third row which may include a bench seat). Behind the rearmost row of vehicle seating assemblies 14 (i.e., in the depicted embodiment the second row R2) may be a cargo space 102 configured to store and haul items. The vehicle seating assemblies 14 in the second row R2, and optional third row, may define a second occupant space 106 configured to hold passengers of the vehicle 10. A center console 94 may be positioned between the vehicle seating assemblies 14 of each of the rows. The seating assemblies 14 include the seat bottom 22 and the seat back 26. The seat back 26 is rotatably coupled to the seat bottom 22 such that the seat back 26 may rotate in vehicle forward and vehicle rearward directions. The seating assemblies 14 may include a modular comfort carrier 110 extending across the seat bottom 22 and the seat back 26.

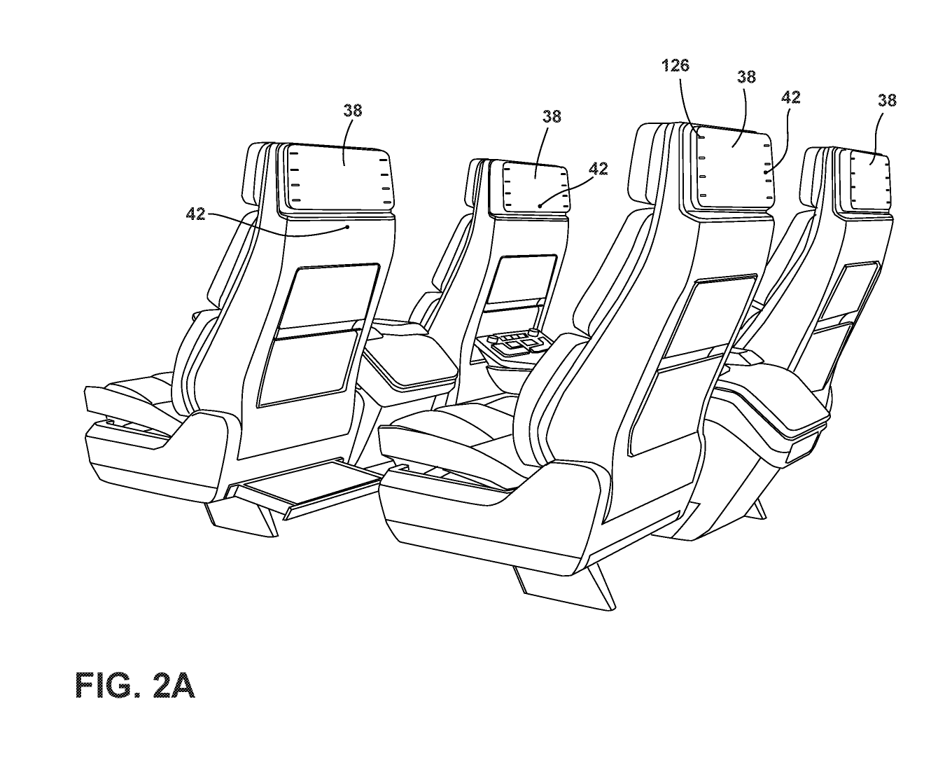

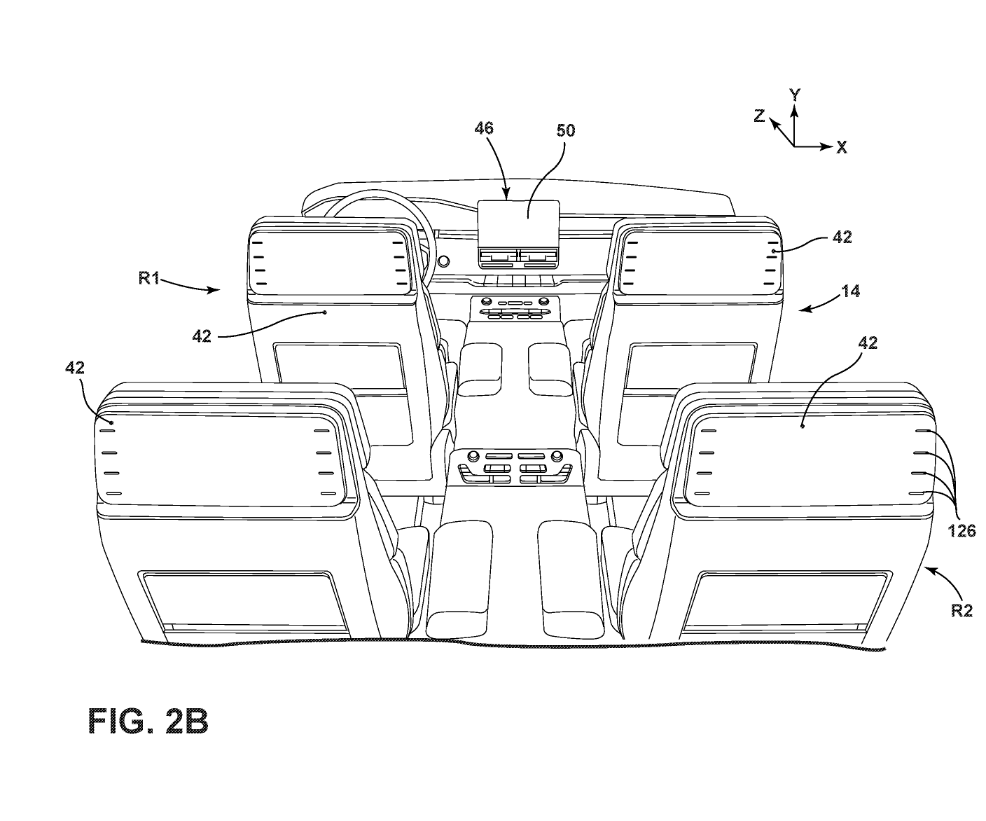

Referring now to FIGS. 1A-1G, 2A and 2B, the back panel 34 of the seat back 26 may define a recessed portion 118 in which the display 38 is positioned (FIG. 1D). In the depicted embodiment, the recessed portion 118 is positioned at a top of the seat back 26, proximate the head rest area 30, but may also be positioned at a middle or side of the seat back 26. In the depicted embodiment, the recessed portion 118 extends to the sides and top of the back panel 34. In another example, the recessed portion 118 extends across a width of the back panel 34. The recessed portion 118 may define lips which extend out of the back panel 34 in a vehicle rearward direction and act to “frame” the display 38. The lips may fully or partially frame the display 38. The display 38 is disposed in, or otherwise inset into, the recessed portion 118. The back panel 34 may be a hard panel (e.g., formed of a polymeric material) and/or may be formed of fabric stretched over a seat frame. In various embodiments, the display 38 may be partially, substantially or fully planar with a rear surface of the back panel 34. The display 38 is connected to the back panel 34 of the seat back 26 via a mount 122. The mount 122 may be configured to provide rotational and translational movement to the display 38 relative to the seat back 26 of the vehicle seating assembly 14. The mount 122 may provide motion to the display in X-, Y-, and Z-directions. For example, the display 38 may be tilted, rotated, pulled out and/or pushed in simultaneously or independently. For example, if a passenger located in the passenger vehicle seating assembly 14 of the first row tilts their seat back 26 rearward (e.g., to rest or relax), an occupant of the seating assembly 14 in the second row may tilt the display 38 upward to adjust a viewing angle of the display 38. Similarly, the display 38 may be tilted or rotated toward an inboard or outboard direction within the vehicle 10 to adjust for glare due to external light sources (e.g., the sun and/or artificial lighting) or to provide privacy (e.g., such that other occupants may not see what is shown on the display 38) for the user of the particular display 38. The mount 122 may be thin enough such that the displays 38 have a substantially flush appearance between the back panel 34 or define a slight gap. The gap may extend around the displays 38, or only around a portion of the displays 38. The gap may have a thickness of between about 1 mm and about 25 mm, or between about 5 mm and about 15 mm, or between 7 mm and about 10 mm. The thickness of the gap can be measured from a rear surface of the display 38 to the surfaces of the recessed portion 118. The display 38 and/or the recessed portion 118 may be sized such that the display 38 accounts for greater than about 70%, 80%, 90%, 95% or 99% of the recessed portion 118.

In the depicted embodiment, the displays 38 include a plurality of physical user input buttons 126. The buttons 126 may be mechanical actuation buttons. The buttons 126 may be disposed along sides, a top, a bottom, corners and/or in the center of the displays 38. Additionally or alternatively, the display 38 may be configured to be touch sensitive such that an occupant of the vehicle 10 may touch the display 38 to select or otherwise manipulate what is shown on the display 38. Further, the buttons 126 may include one or more resistive, capacitive (e.g., surface, projected, self and/or mutual capacitance), surface acoustic wave, infrared grid, infrared acrylic projection, optical imaging, dispersive signal and/or acoustic pulse recognition buttons 126, configured to indicate contact of an occupant's hand and/or finger with the display 38. The display 38 may include one or more microphones, audio jacks, or connections and/or audio speakers configured to allow audio information to be input and output from the display 38. Additionally or alternatively, the speakers and/or microphones may be disposed within the seat back 26 or in the center consoles 94 (FIG. 1E). The speakers associated with the displays 38 may be directionally oriented such that noise from the speakers is minimized within the cabin 58 and maximized in the second occupant space 106. The displays 38, HMI 46 and heads up display 68 may be configured to show one or more images to occupants of the vehicle seating assemblies 14 and/or function as an interactive infotainment system. For example, the display 38, HMI 46 and heads-up display 68 may be configured to allow occupants of the seating assemblies 14 to play games (e.g., single player games such as solitaire, multiplayer games such as chess with a computer or occupants in other seating assemblies 14), access the internet, browse and play stored media, access information about the vehicle 10 (e.g., speed, fuel level, tire pressure, etc.), send messages (e.g., through an in-vehicle messaging system or to other vehicles) and/or access positional and route information (e.g., via GPS). It will be understood that certain restrictions on available infotainment features (e.g., games, internet access, etc.) may be restricted from being shown on the heads-up display 68 and/or HMI 46 when the vehicle 10 is being operated (e.g., in a drive gear or moving) to promote safety and alertness of a driver of the vehicle 10. Additionally, the display 38, HMI 46 and heads-up display 68 may be configured to use the vehicle communication system 12 to display one or more video signals from one or more of the cameras 42 placed within, or exterior to, the vehicle 10, as explained in greater detail below.

Disposed around the interior of the vehicle 10 may be a plurality of cameras 42. The cameras 42 may be configured to capture an image and transmit, via video signal, the image over the vehicle communication system 12 to the display 38, the HMI 46 and/or heads-up display 68. The video signals produced by the cameras 42 may be live images (i.e., real time video of what the cameras 42 are imaging). In other words, the video signals by the cameras 42 may be streamed. In embodiments where the HMI 46 shows images from the cameras 42, the screen 50 may be split or otherwise provide picture-in-picture capability to provide more than one video image (e.g., one image for each of the vehicle seating assemblies 14 of the first row R1) or show both an image from one of the cameras 42 in addition to rout/navigation information. The cameras 42 may include complementary metal-oxide-semiconductor (CMOS) and/or charge-coupled device (CCD) type image sensors. In various embodiments, the cameras 42 are configured to image the first and/or second occupant spaces 16, 106. In a specific embodiment, the cameras 42 may include two imagers configured to provide a stereoscopic image or enhanced functionality to the camera 42 (e.g., varying levels of zoom, brightness/contrast control, three-dimensional gesture recognition).

The cameras 42 may be placed in a plurality of locations around the vehicle 10. For example, cameras 42 may be positioned in a bezel of the HMI 46, the cluster hood 78 (e.g., in a lip of the hood 78 or protruding above or below the hood 78), in the steering wheel 86 (e.g., on a grip portion or a central horn portion), on the steering column 90, on and/or in the instrument panel 62 (e.g., protruding therefrom or concealed within a veneer or trim component), the A-pillar 70, a B-pillar 138, the center consoles 94, trim components of the doors 60, the headliner 74, a visor attached to the headliner 74, the back panel 34 of the seat back 26 and/or the displays 38. In embodiments where the cameras 42 are in the displays 38, a single camera 42 may be positioned proximate the buttons 126, proximate a top edge, proximate a bottom edge and/or positioned within a bezel or frame of the display 38. It will be understood that in examples where the camera 42 is positioned within the display 38, movement of the display 38 relative to the back panel 34 may alter the area imaged by the camera 42. In embodiments where the camera 42 is disposed within a veneer or trim component of the instrument panel 62, the camera may be concealed by a pattern (e.g., wood grain, leather pattern, etc.) or lettering on the veneer. In embodiments where the cameras 42 are disposed exterior of the displays 38 and/or HMI 46, the cameras 42 may be rotatably mounted such that the space the cameras 42 image may be adjusted by an occupant of the vehicle 10. In embodiments where the cameras 42 are mounted or disposed within the displays 38, the imaging space of the cameras 42 may be altered through translation and/or rotation of the displays 38, as explained above. As explained above, the cameras 42 are configured to image the first and second occupant spaces 16, 106. Specifically, the cameras 42 may be positioned to image a face of an occupant in the vehicle seating assembly 14. The cameras 42 may be configured to transmit a video signal and/or still images to one or more of the displays 38, the HMI 46 and/or the heads-up display 68. The cameras 42, the displays 38, the HMI 46 and/or the heads-up display 68 may all transmit data between one another via a wired connection, or wirelessly, as explained in greater detail below. Further, the audio picked up by the microphones of the displays 38, the HMI 46 and/or the heads-up display 68 may also be transmitted among the displays 38, the HMI 46 and/or the heads-up display 68.

Referring now to FIG. 4, a box diagram of the vehicle 10 is shown in which the vehicle communication system 12 utilizing the cameras 42, the displays 38 and the HMI 46 is implemented. In the depicted embodiment, each of the displays 38 and the HMI 46 include one of the cameras 42. The vehicle communication system 12 includes a controller 154 which is configured to receive and transfer information (e.g., video signals, game information, messages, etc.) between the displays 38 and/or HMI 46. It will be understood that in embodiments incorporating the heads-up display 68, the controller 154 may transmit information (e.g., video signal) to the heads-up display 68 such that the driver of the vehicle 10 may view the information while driving. The information may be transferred within the vehicle communication system 12 via wires or wirelessly (e.g., over an internal Wi-Fi network).

The controller 154 may include a processor 158 and a memory 162 having instructions contained therein that are executed by the processor 158. In one example, the instructions of the memory 162 may include a program to designate the HMI 46 as a “master” input device which may control what is shown on the “slave” displays 38. Further, the memory 162 may also contain instructions to show stored images obtained from the cameras 42 when indicated or under certain circumstances. In another example, the memory 162 may include one or more routines which control the operation, installation, and removal of one or more applications (e.g., Pandora™, Instagram™, YouTube™, music applications, cloud storage applications, an application store, a map application, social media applications, game applications, banking applications, fitness applications, sports applications, news applications, word processing applications, PDF processing applications, weather applications, etc.). In another example, the memory 162 may include a routine configured to allow the occupant to control environmental characteristics about and around the vehicle seating assembly 14 (e.g., air temperature, ambient lighting, heated seats, etc.). The controller 154 may further be connected to one or more modules 166 such as, but not limited to, a body control module, engine control module, steering control module, brake control module, the like or a combination thereof, to provide information related to the vehicle 10 (e.g., speed, location, route information, etc., as explained above). The controller 154 may control the information shared between the displays 38, the HMI 46 and the module 166 such that a variety of information may be displayed to occupants of the vehicle 10 based on their selection (e.g., via the buttons 126 or touch screen interfaces). It will be understood that although depicted as including a single controller 154, the HMI 46 and/or each of the displays 38, may each include a controller for independent control. Further, the heads-up display 68 may also be linked with, or contain its own, controller 154.

In operation, the vehicle communication system 12 is configured to facilitate communication between occupants within the cabin 58 of the vehicle 10. In a first example of operating the vehicle communication system 12, a first camera 42 (e.g., a camera 42 positioned in the instrument panel 62) may image the first occupant space 18 of a seating assembly in the first row R1. A second camera 42 (e.g., a camera 42 positioned in a display 38 of a seating assembly 14 of the first row R1) may image the second occupant space 106 of a seating assembly 14 of the second row R2. The first camera 42 may then generate a first video signal which is transmitted to the display 38, and the second camera 42 may generate a second video signal which is transmitted to the HMI 46. In such an example, face to face communication between occupants in the first and second rows R1, R2 may be facilitated. It will be understood that the vehicle communication system 12 may be operated to allow face-to-face communication between any row of seating assemblies 14 within the vehicle 10 (i.e., even within the same row of seating assemblies 14). Further, use of the vehicle communication system 12 may allow one-way viewing of different locations within the cabin 58 (e.g., monitoring).

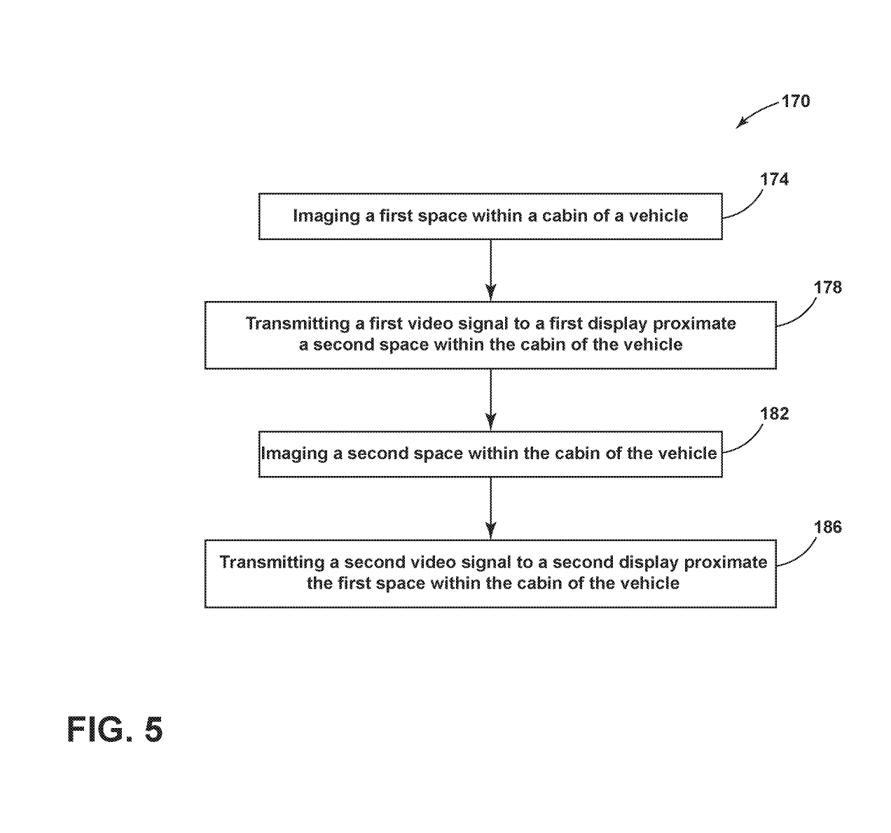

Referring now to FIG. 5, an exemplary method 170 of operating the vehicle communication system 12 is depicted. The method 170 begins with step 174 of imaging a first space within the cabin 58 of a vehicle 10. Imaging may be accomplished using any one of the cameras 42 described in greater detail above. The first space may be the first occupant space 18, the second occupant space 106 or any of the spaces described above. Next, step 178 of transmitting a first video signal to a first display 38 proximate a second space within the cabin 58 of the vehicle 10 is performed. As explained above, transmitting of the first video signal to the first display may be done through either a wired or a wireless connection. By transmitting the first video signal of the first space to the first display proximate the second space in the cabin 58 of the vehicle 10, an occupant of the vehicle 10 may view another place or occupant within the cabin 58 of the vehicle 10. For example, an occupant in the second space may view an occupant of the first space. Next, step 182 of imaging the second space within the cabin 58 of the vehicle 10 is performed. The second space may be the first occupant space 18, the second occupant space 106 or any of the spaces described above. As explained above, imaging may be accomplished using any one of the above-mentioned cameras 42. Next step 186 of transmitting a second video signal to a second display proximate the first space within the cabin 58 of the vehicle 10 is performed. By transmitting the second video signal to the second display proximate the first space, an occupant of the first space may view the occupant of the second space. Allowing the occupants of the first and second spaces to view and communicate with one another allows face-to-face communication within the cabin 58 even though the occupants may be spread across different seating rows (e.g., the first and second rows R1, R2) or in different locations of the vehicle 10. Further, communication may be facilitated in the same row, but between different seats.

Use of the foregoing disclosure may offer several advantages. First, use of the cameras 42 in conjunction with the displays 38 and/or HMI 46 may allow for “face-to-face” communication between occupants, regardless of seating position within the vehicle 10. For example, the driver may select to share the video signal from their associated camera 42 with the display 38 of another occupant. Such an example, may be beneficial, is calming a restless child or infant in the second row R2 or third row of the seating assemblies 14. Second, as explained above, the HMI 46 may exercise a master control feature over the displays 38 such that a parent or guardian located in the driver or first row passenger seating assemblies 14 may control what is shown on the displays 38 of the second and third-row seating assemblies 14. Such a feature may be advantageous in allowing the parent or guardian to ensure occupants of the second and third-row seating assemblies 14 (e.g., children) are performing instructed tasks (e.g., homework) or, if relevant, consuming child appropriate media (e.g., games, movies, internet websites, etc.). Third, use of the cameras 42 may be utilized to store images taken by the cameras 42. In a first example, the vehicle communication system 12 may begin taking images using cameras 42 and store the images after the vehicle 10 has detected an unauthorized entry into the vehicle 10 (e.g., via the body control module, the engine control module or the like) by an intruder. In such a scenario, the cameras 42 may take and store images and/or video of the intruder for later use by law enforcement. In a second example, the cameras 42 may store images and/or video of the occupants for later retrieval (e.g., from a media storage device) and replay on the displays 38, HMI 46 and/or heads-up display 68. It will be understood that such images or video obtained through the cameras 42 may be uploaded to the internet or other cloud-based storage systems.

It will be understood that each of the vehicle seating assemblies 14, as well as the displays 38, may take different configurations based on the embodiments disclosed herein without departing from the spirit of this disclosure.

According to various embodiments, a vehicle cabin includes a first camera and a second camera positioned within the cabin. The first and second cameras are configured to image respective first and second spaces within the cabin. A first display is configured to display a first video signal from the first camera. A second display is configured to display a second video signal from the second camera. Embodiments of the vehicle cabin can include any one or a combination of the following features:
the first and second video signals are live images from the respective first and second cameras;
at least one of the first and second spaces within the cabin is an occupant space of a seating assembly;
the first and second cameras are positioned in different seating rows of the cabin;
at least one of the first and second displays is positioned on a seating assembly;
at least one of the first and second displays is positioned on the seating assembly is rotatable relative to the seating assembly;
at least one of the first and second displays is positioned within a recessed portion of the seating assembly;
at least one of the first and second spaces is a cargo space of a cabin of the vehicle;
at least one of the displays is inset within a recessed portion of a back panel of a seating assembly;
the recessed portion is positioned proximate a headrest area of the seating assembly;
the recessed portion extends across a width of the back panel; and
at least one of the first and second cameras is positioned within at least one of an A-pillar, a steering wheel, an instrument cluster hood, a headliner or a visor.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

For the purposes of describing and defining the present teachings, it is noted that the terms “substantially” and “approximately” are utilized herein to represent the inherent degree of uncertainty that may be attributed to any quantitative comparison, value, measurement, or other representation. The term “substantially” and “approximately” are also utilized herein to represent the degree by which a quantitative representation may vary from a stated reference without resulting in a change in the basic function of the subject matter at issue.

It is to be understood that variations and modifications can be made on the aforementioned structure without departing from the concepts of the present invention, and further it is to be understood that such concepts are intended to be covered by the following claims unless these claims, by their language, expressly state otherwise.

What is claimed is:

1. A vehicle, comprising:
a vehicle seating assembly defining a first occupant space, the assembly comprising:
a seat bottom;
a seat back operably coupled to the seat bottom, the seat back including a head rest area and a back panel;
a display positioned on a rear of the seat back; and
a first camera positioned within the display and configured to transmit a first video signal; and
a human machine interface comprising a screen configured to display the first video signal from the first camera.

2. The vehicle of claim 1, further comprising:
a second camera positioned proximate the vehicle seating assembly and configured to image an occupant of the first occupant space and form a second video signal.

3. The vehicle of claim 1, wherein the second camera is positioned within at least one of an A-pillar, a steering wheel, an instrument cluster hood, a headliner or a visor.

4. The vehicle of claim 2, wherein the display is configured to show the second video signal.

5. The vehicle of claim 1, wherein the first camera is configured to image a second occupant space behind the vehicle seating assembly.

6. The vehicle of claim 1, further comprising:
a heads-up display system, the heads-up display system configured to display the first video signal.

7. A vehicle, comprising:
a first vehicle seating assembly defining a first occupant space;
a second vehicle seating assembly defining a second occupant space;
a display positioned on a rear of the first seating assembly; and
a camera positioned within the display and configured to image the second occupant space.

8. The vehicle of claim 7, wherein the display is configured to display a video signal from the camera.

9. The vehicle of claim 7, wherein the display and the camera are configured to rotate relative to the seat assembly.

10. The vehicle of claim 7, wherein the display is inset within a recessed portion of a back panel of the first seating assembly.

11. The vehicle of claim 10, wherein the recessed portion is positioned proximate a headrest area of the seating assembly.

12. The vehicle of claim 10, wherein the recessed portion extends across a width of the back panel.

13. The vehicle of claim 7, further comprising:
a second camera configured to image a cargo space of a cabin of the vehicle.

14. A vehicle cabin, comprising:
a first camera and a second camera positioned within the cabin and configured to image respective first and second spaces within the cabin;
a first display configured to display a first video signal from the first camera; and
a second display configured to display a second video signal from the second camera.

15. The vehicle cabin of claim 14, wherein the first and second video signals are live images from the respective first and second cameras.

16. The vehicle cabin of claim 15, wherein at least one of the first and second spaces within the cabin is an occupant space of a seating assembly.

17. The vehicle cabin of claim 16, wherein the first and second cameras are positioned in different seating rows of the cabin.

18. The vehicle cabin of claim 17, wherein at least one of the first and second displays is positioned on a seating assembly.

19. The vehicle cabin of claim 18, wherein at least one of the first and second displays is positioned on the seating assembly is rotatable relative to the seating assembly.

20. The vehicle cabin of claim 19, wherein at least one of the first and second displays is positioned within a recessed portion of the seating assembly.
